(19) United States
(12) Patent Application Publication
(10) Pub. No.: US 2022/0309055 A1
(43) Pub. Date: Sep. 29, 2022

(54) INTELLIGENT ASSISTANT FOR A BROWSER USING CONTENT AND STRUCTURED DATA

(71) Applicant: Microsoft Technology Licensing, LLC, Redmond, WA (US)

(72) Inventors: Prithvishankar SRINIVASAN, Seattle, WA (US); Aman SINGHAL, Sammamish, WA (US); Marcelo Medeiros DE BARROS, Redmond, WA (US); Laurentiu Titi NEDELCU, Redmond, WA (US); Scott Andrew BORTON, Seattle, WA (US)

(21) Appl. No.: 17/338,277

(22) Filed: Jun. 3, 2021

Related U.S. Application Data
(60) Provisional application No. 63/164,910, filed on Mar. 23, 2021.

(51) Int. Cl. G06F 16/245; H04L 29/08; G06N 20/00; G06F 16/953

(52) U.S. Cl. CPC G06F 16/245; H04L 67/02; G06N 20/00; G06F 16/953

(57) ABSTRACT

The present disclosure relates to systems, devices, and methods for identifying structured data for any webpage when a user requests the webpage, or the webpage loads in a browser. The systems, devices, and methods extract a portion of the webpage content and use the webpage content to determine the domain of the webpage, extract entities from the webpage content, query one or more datastores with content for structured data based on the domain and the extracted entities and present the structured data with the webpage.

### CROSS-REFERENCE TO RELATED APPLICATIONS

This application claims priority to and the benefit of U.S. Provisional Patent Application No. 63/164,910, filed on Mar. 23, 2021, which is hereby incorporated by reference in its entirety.

### BACKGROUND

Sports fans engage with the browser in multiple ways. One of the main activities which sports fans engage in is to read articles about their favorite player, team, and/or league. Sports fans also engage with the browser in other ways, such as, discussion forums, fan pages, etc. Currently, for sports fans to get notifications about recently ended matches related to a team and/or league, upcoming fixtures, and/or other content, such as, videos and images from recent highlights, the sports fans pro-actively enroll for notifications. The sports fans must download applications to their devices to get the content through mobile application notifications.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One example implementation relates to a method for identifying structured data for a webpage. The method may include extracting a portion of webpage content from the webpage in response to the webpage being requested by a user. The method may include identifying a domain for the webpage using the webpage content. The method may include extracting one or more entities from the webpage content. The method may include querying a datastore for structured data for the webpage using the domain for the webpage and the one or more entities. The method may include obtaining the structured data for the webpage in response to the querying.

Another example implementation relates to a system. The system may include one or more processors; memory in electronic communication with the one or more processors; and instructions stored in the memory, the instructions executable by the one or more processors to: extract a portion of webpage content from the webpage in response to the webpage being requested by a user; identify a domain for the webpage using the webpage content; extract one or more entities from the webpage content; query a datastore for structured data for the webpage using the domain for the webpage and the one or more entities; and obtain the structured data for the webpage in response to the querying.

Another example implementation relates to a computer-readable medium storing instructions executable by a computer device. The computer-readable medium may include at least one instruction for causing the computer device to extract a portion of webpage content from the webpage in response to the webpage being requested by a user. The computer-readable medium may include at least one instruction for causing the computer device to identify a domain for the webpage using the webpage content. The computer-readable medium may include at least one instruction for causing the computer device to extract one or more entities from the webpage content. The computer-readable medium may include at least one instruction for causing the computer device to query a datastore for structured data for the webpage using the domain for the webpage and the one or more entities. The computer-readable medium may include at least one instruction for causing the computer device to obtain the structured data for the webpage in response to the querying.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for identifying structured data for a webpage in accordance with some implementations of the present disclosure.

FIG. 2 illustrates an example method for identifying structure data for a webpage in accordance with some implementations of the present disclosure.

FIG. 3 illustrates an example environment for identifying structured data for a sports webpage in accordance with some implementations of the present disclosure.

FIG. 4 illustrates an example graphical user interface of a webpage displaying structured data for the webpage in accordance with some implementations of the present disclosure.

### DETAILED DESCRIPTION

This disclosure generally relates to identifying structured data for a webpage. Users engage with a browser in multiple ways, such as, reading articles, participating in discussion forums, joining fan pages, and/or watching videos. For example, sports fans engage with the browser by reading articles about their favorite player, team, and/or league. Sports fans also engage with the browser in other ways, such as, by participating in discussion forums, fan pages, etc. Currently, users get notifications about various content through mobile application notifications, which the users pro-actively enrolled for notifications and downloaded the applications on devices of the users (phones, tablets). For example, for sports fans to get information about recently ended matches related to a team and/or league, upcoming fixtures, and/or other content, such as, videos and images from recent highlights, the sports fans pro-actively enroll for notifications.

The present disclosure provides methods and systems that engage users through browser notifications powered by structured data by dynamically examining the content of the webpage that the user is visiting. The structured data may be related to the content of the webpage and/or the domain of the webpage. The present disclosure uses pretrained classifiers and/or machine learning models to help narrow down the notifications to show the users. Using pretrained classifiers and/or machine learning models increases the relevance of the notifications by displaying structured data relevant to the webpage content and/or the type of content, which the user is reading about in the webpage and/or viewing in a video or other multimedia on the webpage.

The methods and systems recognize content from webpages and recommend, via browser notifications, additional content and/or structured data on the same topic or event. For example, when a user visits a web page, a pretrained platform for interactive concept learning (PICL) model is used to extract the title and a brief description from the web page. The extracted data is fed through the pretrained models first to identify whether the extracted data is a sports-related and then to extract entities such as team names, leagues, and player names. Additionally, a content type of the article can be identified. The extracted information is used to query a structured database for schedules, results, highlights, videos, images, audio recordings, and/or other content to be displayed via a notification.

One technical advantage of some implementations of the present disclosure is being able to determine for any webpage, at runtime of the webpage (e.g., when a user requests the webpage or when the webpage loads in a browser), the domain of the webpage, extract entities from the webpage, determine the content type of the webpage, and query one or more datastores for structured data based on the domain, the extracted entities, and/or the content type. By performing the actions at runtime of the webpage, the structured data may be dynamically obtained based on the content the user is currently engaging in on the webpage. As such, the present disclosure provides browser related notifications which actively engage the users with structured content related to the content of the webpage.

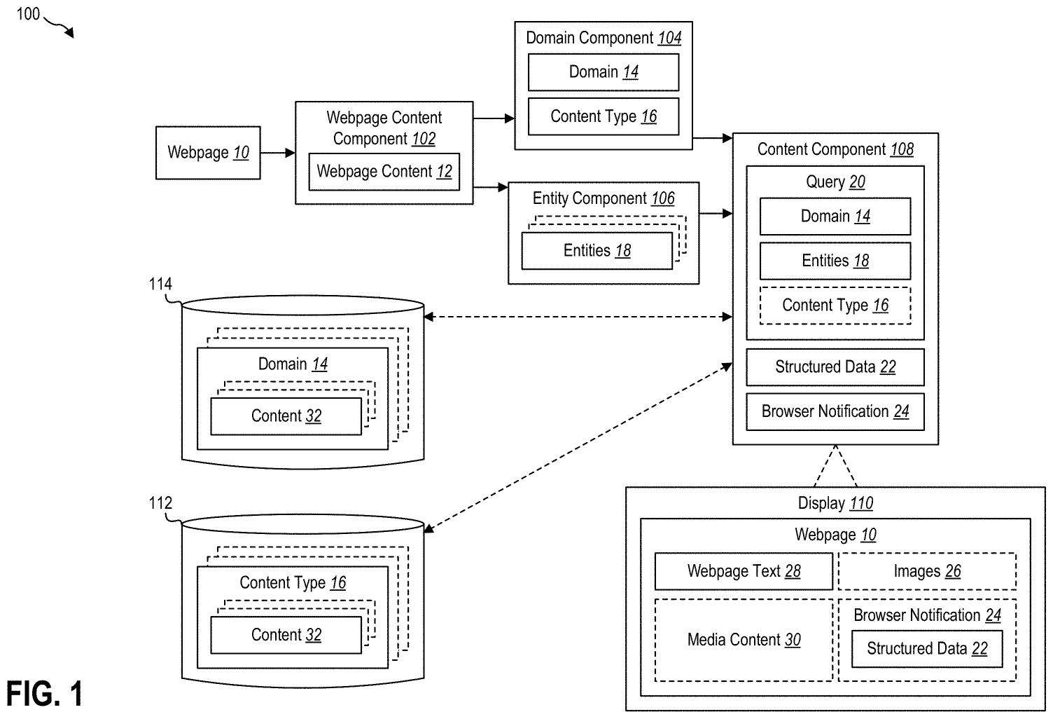

Referring now to FIG. 1, an example environment 100 for identifying structured data 22 for one or more webpages 10. One or more users may use environment 100 to engage with one or more webpages 10 on a display 110 of a device of the users. The users may view or otherwise interact with one or more webpages, for example, via a browser. The browser allows the users to interact with information on the World Wide Web. When a user requests a webpage from a website, the browser retrieves the content of the webpage from a webserver and displays the webpage on the device of the user. The browser may be a browser application on a device of the user. Examples of browsers may include, but are not limited to, EDGE™ and INTERNET EXPLORER™. For example, the users read articles, participate in discussion forums, join fan pages, and/or watch videos on the webpages.

Upon a user selecting a webpage 10 to view, or otherwise interact with, a webpage content component 102 may receive the webpage 10 and may extract webpage content 12 for the webpages. The webpage content component 102 may receive the webpages 10 in response to a user requesting the webpage 10 (e.g., via a browser). The webpage content 12 includes a portion of the textual content extracted from the webpage 10. Examples of webpage content 12 include, but are not limited to, articles, title of the webpage, a brief description from the webpage, hypertext markup language (HTML) content, images, and/or videos. The webpage content component 102 may scrape or otherwise obtain the webpage content 12 from the webpage 10.

In some implementations, the webpage content component 102 uses one or more machine learning models to identify the webpage content 12. For example, a pretrained platform for interactive concept learning (PICL) model is used to extract the webpage content 12 from the webpage 10. As such, the webpage content component 102 identifies the webpage content 12 dynamically upon the user requesting the webpage 10. The webpage content component 102 may communicate the webpage content 12 to a domain component 104 and/or an entity component 106.

The domain component 104 receives the webpage content 12 and may identify the domain 14 of the webpage content 12. The domain 14 of the webpage content 12 indicates different genres or categories of the webpage 10. Domains 14 may include, but are not limited to, sports, weather, entertainment, finance, politics, and/or travel. In addition, the domain component 104 may identify a content type 16 of the webpage content 12. Example content types 16 include, but are not limited to, multimedia content (videos, images, gifs, recordings), articles, text, social media postings, and/or news feeds. The domain component 104 identifies the domain 14 of the webpage 10 and/or the content type 16 of the webpage content 12 dynamically upon the user requesting the webpage 10 (e.g., via a browser).

In some implementations, the domain component 104 uses one or more machine learning models to identify the domain 14 and/or the content type 16 of the webpage content 12. The machine learning models may be pretrained in an offline environment to identify the domains 14 and/or content types 16 using a variety of webpage content 12 from a plurality of genres and/or categories as training data. For example, the domain component 104 uses a machine learning multiclass classifier that determines the domain 14 and/or content type 16 of the webpage content 12.

The entity component 106 also receives the webpage content 12 and extracts one or more entities 18 mentioned in the webpage content 12. Entities 18 may include, but are not limited to, location names, sport team names, business names, and/or individual names. For example, for a weather article, the entity extractor extracts the name of the cities mentioned in the article. Another example includes a political article, and the entity extractor extracts the name of the politicians mentioned in the article. Another example includes a sports article, and the entity extractor extracts the name of the sports teams and players mentioned in the article. The entity component 106 may extract the entities 18 at the runtime of the webpage 10 (e.g., in response to a user requesting the webpage 10 via a browser). As such, the entity component 106 extracts the entities 18 from the webpage content 12 dynamically upon the user requesting the webpage 10 (e.g., via a browser).

In some implementations, the entity component 106 extracts the one or more entities 18 by scraping the webpage content 12. In some implementations, the entity component 106 performs string matching to extract the entities 18. In some implementations, the entity component 106 searches smart tags associated with the webpage content 12 to extract the entities 18. In some implementations, the entity component 106 uses one or more machine learning models to extract the entities 18. The machine learning models may include pretrained models that are trained based on, for example, the domains 14 of the webpages 10. As such, different machine learning models may be selected based on the domain 14 of the webpage 10 to use for the entity extraction.

The content component 108 receives the domain 14 for the webpage 10, the extracted entities 18, and/or the content type 16 of the webpage 10 and generates one or more queries 20 for the structured data 22. The content component 108 may execute the query 20 against one or more datastores 112, 114 of the environment 100 to obtain the structured data 22. The datastores 112, 114 may store a plurality of content 32 (e.g., media content, articles, images, text) for different domains 14 and/or content types 16 that are obtained for the structured data 22.

In some implementations, the one or more datastores 112, 114 store the content 32 by a particular domain 14. For example, the datastores 112, 114 store the sports content 32 together and the weather content 32 together, where the sports content 32 and the weather content 32 are stored separately from one another. Another example includes one datastore 112, 114 only storing a particular domain 14 of content. For example, datastore 112 stores content 32 for entertainment, while datastore 114 stores content 32 for finance. In some implementations, the datastores 112, 114 store the content 32 by content type 16. For example, the datastores 112, 114 only stores the content 32 for a particular article content type 32 (injury, game summary, press conferences, etc.). Thus, different datastores 112, 114 may only include content 32 identified for a specific domain or content type 16.

In some implementations, the datastores 112, 114 are content management systems accessible by different computing devices in environment 100. In some implementations, the content 32 comes from a first content provider and is stored in a first datastore 112 and the content 32 comes from a second content provider and is stored in a second datastore 114. As such, the content 32 is published by different content providers and may be stored in separate datastores or the same datastores. In some implementations, the content 32 is published by the same content providers and is stored in the same datastores 112, 114.

The query 20 may identify which content 32 in the datastores 112, 114 is structured data 22. Structured data may include data organized in a format easily used by a database or other technology. In another example, structured data may include data in a standardized format providing information about a webpage and/or entity. The query 20 may use the domain 14 for the webpage 10, the extracted entities 18, and/or the content type 16 to identify which content 32 is related to the webpage content 12 of the webpage 10 and identify the related content 32 as the structured data 22 for the webpage 10. For example, the query 20 may identify content 32 with words or phrases that match the extracted entities 18. The query 20 may identify content 32 from the same domain 14 or content type 16 of the webpage 10. In addition, the query 20 may identify content 32 that is temporally close to an event described in the webpage 10 (e.g., the identified content 32 is published to the datastores 112, 114 near the event).

The content component 108 may obtain the identified content 32 from the one or more datastores 112, 114 may aggregate the identified content 32 together for the structured data 22. In some implementations, the content component 108 may rank, or otherwise order, the obtained content 32 to determine a subset of the content 32 to include in the structured data 22 to present on the webpage 10. The ranking may be based on the temporal proximity of the obtained content 32 to an event discussed on the webpage 10. For example, if the webpage 10 is discussing an entertainment awards show that occurred the night before, the content component 108 may rank content 32 with the awards won during the awards show higher relative to content 32 with awards that actors won last year. In addition, the content component 108 may rank content 32 with the schedule for upcoming television shows for the television shows that won awards in the awards show higher relative to content 32 with schedules for upcoming television shows that were not included in the awards show. The rankings may also be based on a number of entities 18 in common with the obtained content 32. For example, if an article on the webpage 10 is discussing five entities 18, the content component 108 may rank content 32 discussing only one entity 18 in common with the article lower relative to content 32 discussing four entities 18 in common with the article.

One example of structured data 22 related to sports webpages includes information about recently ended matches, team information, player information, league information, upcoming games, championships, team awards, and/or other content, such as, videos, audio recording, and/or images from recent highlights. Another example of structured data 22 related to entertainment webpages about an actor includes information about previous work (movies, television shows, series) for the actor, information about previous awards for the actor, upcoming events for the actor, and/or upcoming work for the actor. Another example of structured data 22 related to weather webpages about a location includes last rainfall, expected rainfall, highest rainfall totals for the year, average expected rainfall for the month, and/or average temperatures for the month.

Another example of structured data 22 related to political webpages include information about the politicians mentioned in the webpage (political party, current office held, previous positions), upcoming events for the politicians, and/or previous events for the politicians. Another example of structured data 22 related to financial webpages includes a name of an organization, when the initial public offering (IPO) occurred, earning reports, stock tickers, board members, and/or when is the next earnings report due. Another example of structured data 22 related to travel webpages includes currency of a location, population, major landmarks, major cities, and/or language spoken. As such, the structured data 22 obtained may be tailored to the domain 14 and/or content type 16 of the webpage 10 that the user is currently engaging with.

The content component 108 may cause the structured data 22 to be presented on a display 110. The content component 108 may generate a notification to send to a device of the user to present the structured data 22. For example, the content component 108 generates a browser notification 24 with the structured data to be presented on the webpage 10.

In addition, the content component 108 may present the structured data 22 at a later time. For example, the user may close or exit the browser and the content component 108 may present the structured data 22 to the user automatically without any navigation required to a webpage. The structured data 22 may be identified based on the browsing history of the user or the browser (e.g., information about the last webpage accessed by the user or the browser and/or a genre of webpages frequently visited by the user or the browser). The content component 108 may store or otherwise associate information about the browsing history to identify the structured data that may be of interest to the user. For example, if the user is browsing a webpage about the Seattle Seahawks and closes or exits the browser, when the user opens the browser again, the content component 108 may automatically obtain structured data 22 based on the information about the browsing history of the user and present the obtained structured data 22 for the Seattle Seahawks prior to any navigation occurring by the user to another webpage.

The structured data 22 may be presented on the webpage 10 on a display 110 of a device while the user is engaging with the webpage 10 (e.g., reading articles on the webpage 10 or other webpage text 28, participating in discussion forums, joining fan pages, watching media content 30, and/or looking at images 26). The structured data 22 may be presented in an overlay on the webpage 10. For example, a browser notification 24 is generated with the structured data 22 in an overlay of a portion of the webpage 10. The overlay may be presented in an area of the webpage without any text, media, or images. In addition, the structured data 22 may be presented adjacent to the webpage text 28, media content 30, and/or images 26 displayed on the webpage 10. The structured data 22 may also be presented below, above, and/or next to the webpage text 28, the media content 30, and/or the images 26 displayed on the webpage 10. In addition, the structured data 22 may have visually distinct display attributes (e.g., different border, different shading, overlays) from the display attributes of the webpage 10 to highlight and/or identify the structured data 22.

One example use case includes a user browsing a webpage 10 about a gaming company. A browser notification 24 is presented while the user is browsing the webpage 10 with structured data 22 about the gaming company where the structured data 22 includes information about the IPO for the gaming company, a current stock price for the company, earning reports for the gaming company, and a video discussing the stock price for the company.

Another example use case includes a user commenting on a discussion forum on a webpage 10 about an election. While the user is interacting with the discussion forum (e.g., reading comments and/or providing comments), the structured data 22 related to the election is presented on the webpage 10. The structured data 22 includes the political party of politicians involved in the election, a schedule of upcoming speaking engagements for the politicians, recent speeches the politicians, and/or previous positions held by the politicians.

Another example use case includes a user checking a weather webpage 10 for a destination. A browser notification 24 is presented in an overlay on the webpage 10 while the webpage 10 is displayed with the structured data 22 for the weather for the destination. The structured data 22 includes the average temperatures for the destination, an expected rainfall for the destination, the highest rainfall for the year, and when the last rainfall occurred.

Another example use case includes a user interacting with a fan club webpage 10 of an actor. A notification with the structured data 22 for the actor is presented on the fan club webpage 10 while the user is interacting with the fan club webpage 10. The structured data 22 includes upcoming movies for the actor, upcoming events for the actor, awards the actor won, and previous movies of the actor.

The environment 100 may have multiple machine learning models running simultaneously. Examples of the machine learning models may include, but are not limited to, a platform for interactive concept learning (PICL) model, a multiclass classifier, pretrained domain specific models, and/or an inquiry-based learning (IBL) model.

In some implementations, one or more computing devices (e.g., servers and/or devices) are used to perform the processing of environment 100. The one or more computing devices may include, but are not limited to, server devices, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the webpage content component 102, the domain component 104, the entity component 106, the content component 108, the datastores 112, 114, and/or the display 110 are implemented wholly on the same computing device. Another example includes one or more subcomponents of the webpage content component 102, the domain component 104, the entity component 106, the content component 108 the datastores 112, 114, and/or the display 110 implemented across multiple computing devices. Moreover, in some implementations, the webpage content component 102, the domain component 104, the entity component 106, and/or the datastores 112, 114 may be implemented are processed on different server devices of the same or different cloud computing networks.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular embodiment. In some implementations, the components of the environment 100 include hardware, software, or both. For example, the components of the environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

As such, environment 100 engages users by dynamically examining the content of the webpage 10 a user in interacting with and providing related or relevant structured data 22 to the content of the webpage 10. The structured data 22 may be presented through browser notifications 24 powered by the structured data 22.

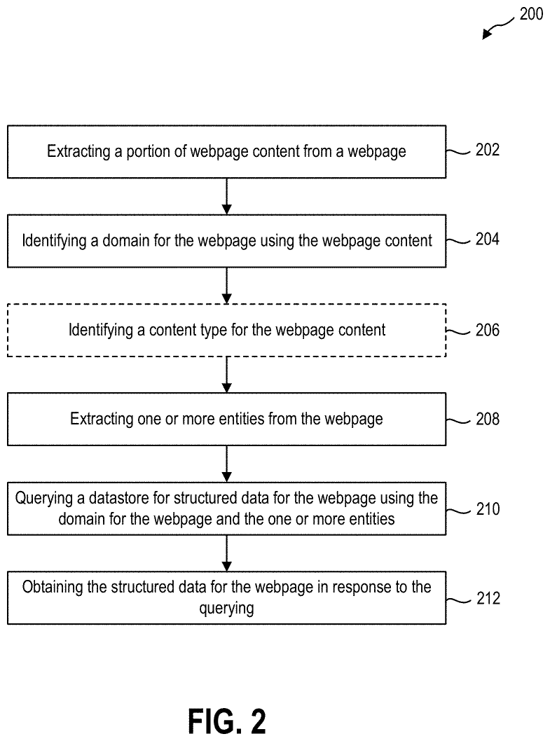

Referring now to FIG. 2 illustrated is an example method 200 for identifying structured data for a webpage performed by one or more computing devices of environment 100. The actions of method 200 may be performed dynamically as the user interacts with the webpage 10 in response to the user requesting the webpage 10. The actions of method 200 are discussed below with reference to the architecture of FIG. 1 but may be applicable to other specific environments.

At 202, method 200 includes extracting a portion of webpage content from a webpage. A webpage content component 102 may receive, or otherwise access, the webpage 10 and may extract webpage content 12 for the webpages. The webpage content component 102 may receive or access the webpages 10 in response to a user requesting the webpage 10 (e.g., via a browser). The webpage content 12 includes a portion of the textual content extracted from the webpage 10. Examples of webpage content 12 include, but are not limited to, articles, title of the webpage, a brief description from the webpage, hypertext markup language (HTML) content, images, and/or videos. The webpage content component 102 may scrape or otherwise obtain the webpage content 12 from the webpage 10. The webpage content component 102 may also use one or more pretrained models (e.g., a PICL model) to extract the webpage content 12.

At 204, method 200 includes identifying a domain for the webpage using the webpage content. The domain component 104 may receive the webpage content 12 and may identify the domain 14 of the webpage content 12. The domain 14 of the webpage content 12 indicates different genres or categories of the webpage 10. Domains 14 may include, but are not limited to, sports, weather, entertainment, finance, politics, and/or travel. The domain component 104 may use one or more pretrained models to identify the domain 14 of the webpage content 12.

At 206, method 200 may optionally include identifying a content type for the webpage content. The domain component 104 may identify a content type 16 of the webpage content 12. Example content types 16 include, but are not limited to, multimedia content (videos, images, gifs, recordings), articles, text, social media postings, and/or news feeds. The domain component 104 may use one or more pretrained models to identify the content type 16 of the webpage content 12.

At 208, method 200 may include extracting one or more entities from the webpage. The entity component 106 may also receive the webpage content 12 and may extract one or more entities 18 mentioned in the webpage content 12. Entities 18 may include, but are not limited to, location names, sport team names, business names, and/or individual names. In some implementations, the entity component 106 extracts the one or more entities 18 by scraping the webpage content 12. In some implementations, the entity component 106 performs string matching to extract the entities 18. In some implementations, the entity component 106 searches smart tags associated with the webpage content 12 to extract the entities 18. In some implementations, the entity component 106 uses one or more pretrained models to extract the entities 18. The pretrained models may be domain specific trained models that are trained based on, for example, input data for different domains. As such, different models may be selected based on the domain 14 of the webpage 10 to use for the entity extraction.

At 210, method 200 may include querying a datastore for structured data for the webpage using the domain for the webpage and the one or more entities. The content component 108 receives the domain 14 for the webpage 10, the extracted entities 18, and/or the content type 16 of the webpage 10 and generates one or more queries 20 for the structured data 22. The content component 108 may execute the queries 20 against one or more datastores 112, 114 of the environment 100 to obtain the structured data 22. The datastores 112, 114 may store a plurality of content 32 (e.g., media content, articles, images, text) for different domains 14 and/or content types 16 that is obtained for the structured data 22.

The query 20 may identify which content 32 in the datastores 112, 114 is structured data 22. The query 20 may use the domain 14 for the webpage 10, the extracted entities 18, and/or the content type 16 to identify which content 32 is related to the webpage content 12 of the webpage 10 and identify the related content 32 as the structured data 22 for the webpage 10. For example, the query 20 may identify content 32 with words or phrases that match the extracted entities 18. The query 20 may identify content 32 from the same domain 14 or content type 16 of the webpage 10. In addition, the query 20 may identify content 32 that is temporally close to an event described in the webpage 10 (e.g., the identified content 32 is published to the datastores 112, 114 near the event).

At 212, method 200 may include obtaining the structured data for the webpage in response to the querying. The content component 108 may obtain the identified content 32 from the one or more datastores 112, 114 may aggregate the identified content 32 together for the structured data 22. In some implementations, the content component 108 may rank, or otherwise order, the obtained content 32 to determine a subset of the content 32 to include in the structured data 22 to present on the webpage 10. The ranking may be based on the temporal proximity of the obtained content 32 to an event discussed on the webpage 10. The rankings may also be based on a number of entities 18 in common with the obtained content 32. The content component 108 may select ten items of the structured data 22 to present (e.g., the ten items of structured data 22 with the highest rank).

The content component 108 may cause the structured data 22 to be presented on a display 110. The content component 108 may generate one or more notifications to send to a device of the user to present the structured data 22 (e.g., a browser notification 24 with the structured data 22).

One example use case is the user is watching a video of a baseball game on a webpage 10. A browser notification 24 with structured data 22 for the sports game is presented in an overlay on the webpage 10 near the video. The structured data 22 provides information about the players on the teams in the baseball game, current rankings of the teams in the league, the upcoming schedule of the teams in the baseball game, game stats for the baseball game, and player statistics for the players in the baseball game.

The actions of method 200 may be performed at runtime of the webpage 10, resulting in the structured data 22 being dynamically obtained based on the content of what the user is engaging in on the webpage 10. As such, method 200 provides structured data 22 related to the content of the webpage 10 while the user is engaging with the webpage 10.

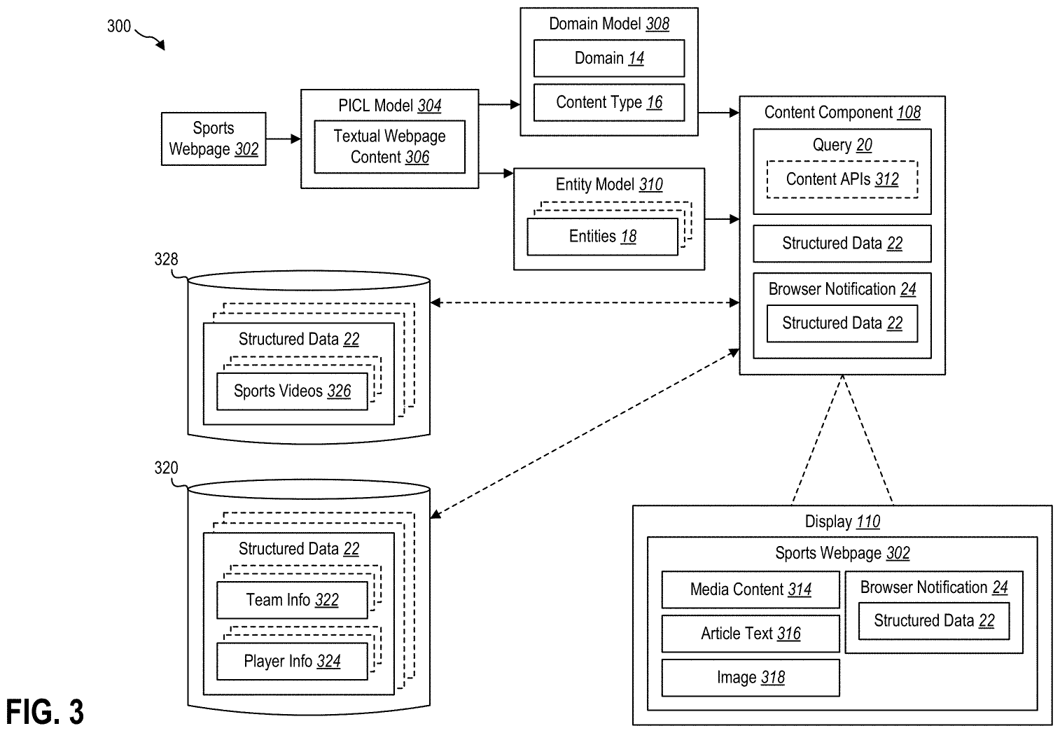

Referring now to FIG. 3, illustrated is an example environment 300 for identifying structured data 22 for a sports webpage 302. Users may use environment 300 for engaging with sports webpages 302 via a display 110 of a device of the users. The users may view or otherwise interact with one or more sports webpages 302, for example, via a browser. For example, the users select different sports webpages 302 to read articles, participate in discussion forums, join fan pages, and/or watch videos.

Upon the user selecting a sports webpage 302 to view or otherwise interact with, a pretrained PICL model 304 receives or accesses the sports webpage 302 and the PICL model 304 extracts textual webpage content 306 from the sports webpage 302 (e.g., title of the webpage, a brief description of the webpage, HTML content, and/or a portion of articles). The textual webpage content 306 is sent to a domain model 308 and an entity model 310 for further processing.

A pretrained domain model 308 receives the textual webpage content 306 and verifies that the domain 14 of the sports webpage 302 is sports. In addition, the domain model 308 may identify a content type 16 of the webpage content 12. Example content types 16 include, but are not limited to, multimedia content (videos, images, gifs, recordings), articles, text, social media postings, and/or news feeds. As such, the domain model 308 verifies the domain 14 of the sports webpage 302 and/or identifies the content type 16 of the sports webpage at runtime of the sports webpage 302 (e.g., upon the user requesting the sports webpage 302 via a browser).

A pretrained entity model 310 receives the textual webpage content 306 and extracts one or more entities 18 mentioned in the textual webpage content 306. Entities 18 may include, for example, name of sports teams, name of players, league names, team managers or other individuals' names, and/or location names. The entity component 106 may extract the entities 18 the sports webpage at runtime of the sports webpage 302 (e.g., upon the user requesting the sports webpage 302 via a browser). Environment 300 may have one or more of the PICL model 304, the domain model 308, and/or the entity model 310 running concurrently.

A content component 108 receives the domain 14, the extracted entities 18, and/or the content type 16 of the sports webpage 302 and generates one or more queries 20 for the structured data 22. The content component 108 may execute the query 20 against one or more datastores 320, 328 of environment 300 for the structured data 22. The structured data 22 may include, but is not limited to, highlights, schedule, team roster, team information, recent scores, championships, events, schedules, player information (where the player was before, team currently on, awards), and/or league information. The datastores 320, 328 may store a plurality of structured data 22. For example, the datastore 320 stores team information 322 and player information 324. The datastore 320 may have team information 322 and player information 324 for a variety of different sports and/or teams. In addition, the datastore 328 may store sports videos 326. The sports videos 326 may include highlights from games and/or interviews. The datastore 328 may store sports videos 326 for different sports and/or teams. As such, the content component 108 may access different datastores 320, 328 in environment 300 to obtain different structured data 22 for the sports webpage 302.

The query 20 may execute one or more content application programming interfaces (APIs) 312 to identify a specific datastore 320, 328 and/or a specific type of structured data 22 to obtain from the datastore 320, 328. One example content API 312 includes a smart tags API to access a datastore 320, 328 for a specific type of structured data 22 (e.g., injuries, highlights, transfer) identified by the smart tags. Another example content API 312 includes a video API to access a datastore 320, 328 with sports videos 326 for the structured data 22. Another example content API 312 includes a sports fabric API to access a datastore 320, 3287 with schedule information and game results for the structured data 22.

The content component 108 may rank, or otherwise order, the obtained structured data 22 to determine a subset of the structured data 22 to present on the sports webpage 302. The ranking may be based on the temporal proximity of the obtained content 32 to an event discussed on the webpage 10. For example, if the webpage 10 is discussing a sports game, the content component 108 may rank content 32 with the score for the sports game higher relative to content 32 with the score from a sports game for the team two weeks ago. The rankings may also be based on a number of entities 18 in common with the obtained content 32. For example, if an article on the webpage 10 is discussing a sports team and the players of the sports team, the content component 108 may rank content 32 discussing only the sports team lower relative to content 32 discussing the sports team and three of the players. The content component 108 may select a subset of the structured data 22 to present (e.g., the five items of structured data 22 with the highest rank).

The content component 108 may generate a browser notification 24 to send to a device of the user to present the structured data 22 on the display 110. The structured data 22 is presented on the sports webpage 302 while the user is engaging with the sports webpage 302 (e.g., reading articles on the webpage 10 or other webpage text 28, participating in discussion forums, joining fan pages, watching media content 30, and/or looking at images 26). The structured data may be presented in an overlay of the sports webpage 302. In addition, the structured data may be presented next to, adjacent to, above, and/or below article text 316, media content 314 (e.g., videos, audio recordings), and/or images 318 displayed on the sports webpage 302. The structured data 22 may have visually distinct display attributes (e.g., different border, different shading, overlays) from the display attributes of the webpage 10 to highlight and/or identify the structured data 22.

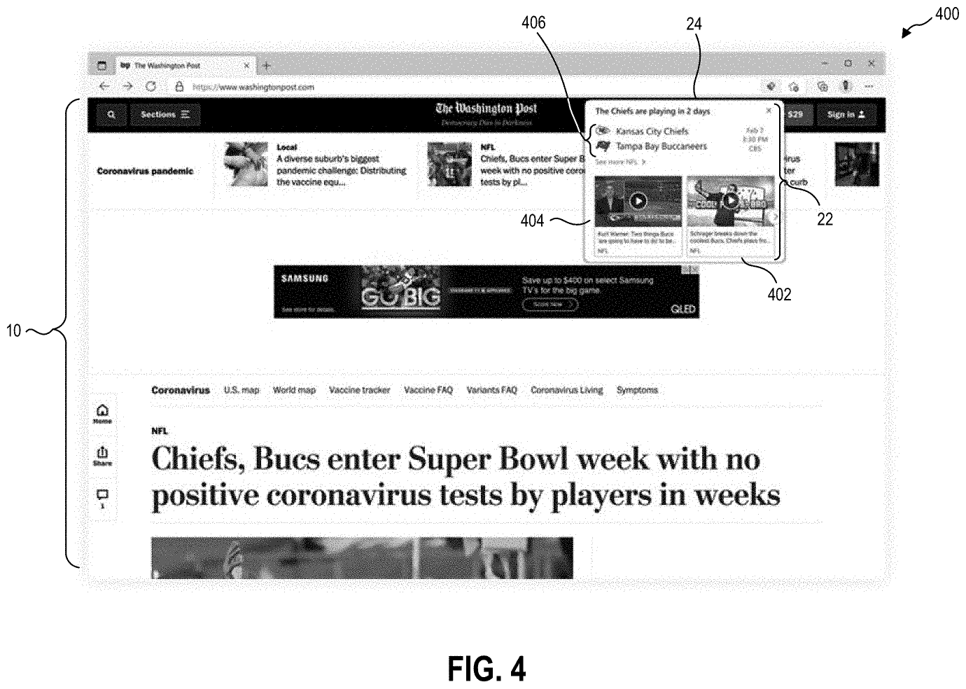

Referring now to FIG. 4, illustrated is an example of a graphical user interface 400 of a webpage 10 presented on a display 110 (FIG. 1, FIG. 3). The webpage 10 may be presented in a browser. The webpage 10 may include a sports article discussing a sports game recently played by two sports teams. Upon the user selecting the webpage 10 to view, the components of environment 100 or 200 may automatically determine the webpage content (e.g., webpage content 12, 306), determine the domain 14 of the webpage 10, extract entities 18 from the webpage content, and query one or more datastores for structured data 22 related to the webpage content to display.

The webpage 10 may include a browser notification 24 with the structured data 22. The structured data 22 includes a recent score 406 of the sports game mentioned in the article of the webpage. The structured data 22 includes videos 402, 404 of highlights from the game and interviews about the game. The structured data 22 is displayed in an overlay with visually distinct display attributes (e.g., different border) from the display attributes of the webpage 10 to highlight and/or identify the structured data 22. As such, the browser notification 24 may actively engage the user with structured data 22 related to the content of the webpage 10.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a regression model, a language model, an object detection model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining and the like. Also, “determining” can include receiving (e.g., receiving information), accessing (e.g., accessing data in a memory) and the like. Also, “determining” can include resolving, selecting, choosing, establishing and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

### INDUSTRIAL APPLICABILITY

The present disclosure is related to methods and systems for providing information with structured data to users based on the content of the webpage that the user is visiting. The methods and systems engage users through browser notifications powered by structured data by dynamically examining the content of the webpage that the user is visiting. The structured data is related to the content of the webpage and/or the domain of the webpage. The methods and systems use pretrained classifiers and/or machine learning models to help narrow down the notifications to show the users. Using pretrained classifiers and/or machine learning models increases the relevance of the notifications by displaying structured data relevant to the webpage content and/or the type of content, which the user is reading about in the webpage and/or viewing in a video or other multimedia on the webpage.

The methods and systems recognize content from webpages and recommend, via browser notifications, additional content and/or structured data on the same topic or event. For example, when a user visits a web page, a pretrained PICL model is used to extract the title and a brief description from the web page. The extracted data is fed through the pretrained models first to identify if the extracted data is a sports page or not and then to extract entities such as team names, leagues, and player names. Additionally, a content type of the article can be identified. The extracted information is used to query a structured database for schedules, results, highlights, videos, images, audio recordings, and/or other content to be displayed via a notification.

One technical advantage of some implementations of the methods and systems is determining for any webpage at runtime of the webpage (e.g., when a user requests the webpage or when the webpage loads in a browser), the domain of the webpage, extracting entities from the webpage, determining the content type of the webpage, and querying one or more datastores with content for structured data for the webpage based on the domain, the extracted entities, and/or the content type. By performing the actions at runtime of the webpage, the structured data is dynamically obtained based on the content of what the user is engaging in on the webpage. As such, the methods and systems provide browser related notifications which actively engage the users with structured content related to the content of the webpage.

(A1) Some implementations include a method for identifying structured data (e.g., structured data 22) for a webpage (e.g., webpage 10). The method includes extracting (202) a portion of webpage content (e.g., webpage content 12) from the webpage in response to the webpage being requested by a user. The method includes identifying (204) a domain (e.g., domain 14) for the webpage using the webpage content. The method includes extracting (208) one or more entities from the webpage content. The method includes querying (210) a datastore (e.g., datastores 112, 114, 320,328) for structured data for the webpage using the domain for the webpage and the one or more entities. The method includes obtaining (212) the structured data for the webpage in response to the querying.

(A2) In some implementations of the method of A1, extracting the portion of the webpage, identifying the domain for the webpage, extracting the one or more entities, querying the datastore, and obtaining the structured data occurs dynamically in response to the user requesting the webpage.

(A3) In some implementations, the method of A1 or A2 includes causing the structured data to be presented with the webpage content on a display, wherein the structured data has visually distinct display attributes from display attributes of the webpage.

(A4) In some implementations, the method of any of A1-A3 includes causing the structured data to be presented with the webpage content on a display, wherein the structured data is presented in one or more of a browser notification on a display, an overlay of the webpage content, adjacent to the webpage content, below the webpage content, above the webpage content, or next to the webpage content.

(A5) In some implementations, the method of any of A1-A4 includes identifying a content type of the webpage, and where querying the datastore for the structured data further includes using the content type of the webpage.

(A6) In some implementations of the method of any of A1-A5, one or more pretrained machine learning models are used for extracting the portion of the webpage content, identifying the domain for the webpage, and extracting the one or more entities.

(A7) In some implementations of the method of any of A1-A6, the one or more pretrained machine learning models include one or more of an interactive concept learning (PICL) model, a multiclass classifier, domain specific models, or an inquiry-based learning (IBL) model.

(A8) In some implementations of the method of any of A1-A7, extracting the one or more entities occurs by one or more of scraping the webpage content, performing string matching on the webpage content, or searching smart tags associated with the webpage content.

(A9) In some implementations of the method of any of A1-A8, extracting the webpage content occurs by scraping the webpage.

(A10) In some implementations of the method of any of A1-A9, the portion of the webpage content includes one or more of textual content from the webpage, articles, a title of the webpage, a brief description from the webpage, hypertext markup language (HTML) content, images, or videos.

Some implementations include a system (environment 100 or environment 300). The system includes one or more processors; memory in electronic communication with the one or more processors; and instructions stored in the memory, the instructions being executable by the one or more processors to perform any of the methods described here (e.g., A1-A10).

Some implementations include a computer-readable storage medium storing instructions executable by one or more processors to perform any of the methods described here (e.g., A1-A10).

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for identifying structured data for a webpage, comprising:
extracting a portion of webpage content from the webpage in response to the webpage being requested by a user;
identifying a domain for the webpage using the webpage content;
extracting one or more entities from the webpage content; and
querying a datastore for structured data for the webpage using the domain for the webpage and the one or more entities;
obtaining the structured data for the webpage in response to the querying; and
causing the structured data to be presented with the webpage content on a display.

2. The method of claim 1, wherein extracting the portion of the webpage, identifying the domain for the webpage, extracting the one or more entities, querying the datastore, and obtaining the structured data occurs dynamically in response to the user requesting the webpage.

3. The method of claim 1, wherein the structured data has visually distinct display attributes from display attributes of the webpage.

4. The method of claim 1, further comprising:
causing the structured data to be presented with the webpage content on a display, wherein the structured data is presented in one or more of a browser notification on a display, an overlay of the webpage content, adjacent to the webpage content, below the webpage content, above the webpage content, or next to the webpage content.

5. The method of claim 1, further comprising:
identifying a content type of the webpage, and
wherein querying the datastore for the structured data further includes using the content type of the webpage.

6. The method of claim 1, wherein one or more pretrained machine learning models are used for extracting the portion of the webpage content, identifying the domain for the webpage, and extracting the one or more entities.

7. The method of claim 6, wherein the one or more pretrained machine learning models include one or more of an interactive concept learning (PICL) model, a multiclass classifier, domain specific models, or an inquiry-based learning (IBL) model.

8. The method of claim 1, wherein extracting the one or more entities occurs by one or more of scraping the webpage content, performing string matching on the webpage content, or searching smart tags associated with the webpage content.

9. The method of claim 1, wherein extracting the webpage content occurs by scraping the webpage.

10. The method of claim 1, wherein the portion of the webpage content includes one or more of textual content from the webpage, articles, a title of the webpage, a brief description from the webpage, hypertext markup language (HTML) content, images, or videos.

11. A system, comprising:
one or more processors;
memory in electronic communication with the one or more processors; and
instructions stored in the memory, the instructions executable by the one or more processors to:
extract a portion of webpage content from the webpage in response to the webpage being requested by a user;
identify a domain for the webpage using the webpage content;
extract one or more entities from the webpage content; and
query a datastore for structured data for the webpage using the domain for the webpage and the one or more entities; and
obtain the structured data for the webpage in response to the querying.

12. The system of claim 11, wherein the instructions are further executable by the one or more processors to extract the portion of the webpage, identify the domain for the webpage, extracting the one or more entities, query the datastore, and obtain the structured data dynamically in response to the user requesting the webpage.

13. The system of claim 11, wherein the instructions are further executable by the one or more processors to:
cause the structured data to be presented with the webpage content on a display, wherein the structured data has visually distinct display attributes from display attributes of the webpage.

14. The system of claim 11, wherein the instructions are further executable by the one or more processors to:
cause the structured data to be presented with the webpage content on a display, wherein the structured data is presented in one or more of a browser notification on a display, an overlay of the webpage content, adjacent to the webpage content, below the webpage content, above the webpage content, or next to the webpage content.

15. The system of claim 11, wherein the instructions are further executable by the one or more processors to:
identify a content type of the webpage, and
use the content type of the webpage to query the datastore for the structured data.

16. The system of claim 11, wherein the instructions are further executable by the one or more processors to use one or more pretrained machine learning models for extracting the portion of the webpage content, identifying the domain for the webpage, and extracting the one or more entities, and
wherein the one or more pretrained machine learning models include one or more of an interactive concept learning (PICL) model, a multiclass classifier, domain specific models, or an inquiry-based learning (IBL) model.

17. The system of claim 11, wherein the instructions are further executable by the one or more processors to extract the one or more entities by one or more of scraping the webpage content, performing string matching on the webpage content, or searching smart tags associated with the webpage content.

18. The system of claim 11, wherein the instructions are further executable by the one or more processors to extract the webpage content by scraping the webpage.

19. The system of claim 11, wherein the portion of the webpage content includes one or more of textual content from the webpage, articles, a title of the webpage, a brief description from the webpage, hypertext markup language (HTML) content, images, or videos.

20. A computer-readable medium storing instructions executable by a computer device, comprising:
at least one instruction for causing the computer device to extract a portion of webpage content from the webpage in response to the webpage being requested by a user;
at least one instruction for causing the computer device to identify a domain for the webpage using the webpage content;
at least one instruction for causing the computer device to extract one or more entities from the webpage content; and
at least one instruction for causing the computer device to query a datastore for structured data for the webpage using the domain for the webpage and the one or more entities; and
at least one instruction for causing the computer device to obtain the structured data for the webpage in response to the querying.
